(19) United States
(12) Patent Application Publication
(10) Pub. No.: US 2024/0326205 A1
(43) Pub. Date: Oct. 3, 2024

(54) IMPACT WRENCH

(71) Applicant: MAKITA CORPORATION, ANJO-SHI (JP)

(72) Inventors: Kazunori KINOSHITA, Anjo-shi (JP); Takeshi KAMIYA, Anjo-shi (JP); Yumiko NODA, Anjo-shi (JP)

(21) Appl. No.: 18/613,290

(22) Filed: Mar. 22, 2024

(30) Foreign Application Priority Data
Mar. 27, 2023 (JP) 2023-049792

(51) Int. Cl. B25B 21/02; B25B 23/00; B25F 5/02

(52) U.S. Cl. CPC B25B 21/026; B25B 23/0035; B25F 5/02

(57) ABSTRACT

An impact wrench includes: a brushless motor comprising a stator and a rotor, which rotates relative to the stator, an impact mechanism, which is rotated by the rotor, an anvil, which is impacted by the impact mechanism; and one or more battery-mounting parts, on which one or more battery packs is (are respectively) mounted. The maximum fastening torque of the anvil is 3,200 N·m or more.

### CROSS-REFERENCE TO RELATED APPLICATION

This application claims priority to Japanese patent application no. 2023-049792 filed on Mar. 27, 2023, the contents of which are fully incorporated herein by reference.

### TECHNICAL FIELD

The techniques disclosed in the present specification relate to an impact wrench.

### BACKGROUND ART US 2019/0386634 discloses an impact wrench driven by electric power supplied from a battery pack.

### SUMMARY OF THE INVENTION

It is one, non-limiting object of the present teaching to disclose techniques for designing an impact wrench to have a higher output torque for fastening (tightening) bolts, screws, etc.

In one non-limiting aspect of the present teachings, an impact wrench may comprise: a brushless motor comprising a stator and a rotor, which rotates relative to the stator; an impact mechanism (e.g., a hammer), which is rotated by the rotor; an anvil, which is impacted by the impact mechanism; and one or more battery-mounting parts, on which one or more battery packs is (are respectively) mounted. The maximum fastening torque of the anvil may be 3,200 N·m or more.

According to the techniques disclosed in the present specification, an impact wrench can be designed such that the anvil applies a higher torque.

### BRIEF DESCRIPTION OF THE DRAWINGS

FIG. 1 is a front view that shows an impact wrench according to a first embodiment of the present teachings.

FIG. 2 is a top view that shows the impact wrench according to the first embodiment.

FIG. 3 is a cross-sectional view that shows a portion of the impact wrench according to the first embodiment.

FIG. 4 schematically shows a stator according to the first embodiment.

FIG. 5 schematically shows an anvil according to the first embodiment.

FIG. 6 is a front view that shows an impact wrench according to a second embodiment of the present teachings.

FIG. 7 is a top view that shows an impact wrench according to a third embodiment of the present teachings.

FIG. 8 is a top view that shows an impact wrench according to a fourth embodiment of the present teachings.

FIG. 9 is a side view that shows an impact wrench according to a fifth embodiment of the present teachings.

FIG. 10 is a top view that shows an impact wrench according to a sixth embodiment of the present teachings.

FIG. 11 is a side view that shows an impact wrench according to a seventh embodiment of the present teachings.

FIG. 12 is a front view that shows an impact wrench according to an eighth embodiment of the present teachings.

### DETAILED DESCRIPTION OF THE INVENTION

As was noted above, an impact wrench may comprise: a brushless motor comprising a stator and a rotor, which rotates relative to the stator; an impact mechanism (e.g., a hammer), which is rotated by the rotor; an anvil, which is impacted by the impact mechanism; and one or more battery-mounting parts, on which one or more battery packs is (are respectively) mounted. The maximum fastening torque of the anvil may be 3,200 N·m or more.

According to the above-mentioned configuration, the anvil of the impact wrench can be driven (rotated) with or at a higher torque.

In one or more embodiments, the sum total of the rated voltage(s) of the battery pack(s) may be 36 V or more. The outer diameter of the stator may be 50 mm or more. The maximum output of the brushless motor may be 1,250 W or more. The rotational speed of the anvil may be 600 rpm or more and 2,400 rpm or less. The impact rate of the impact mechanism may be 900 ipm or more and 3,200 ipm or less. The weight (mass) of a hammer of the impact mechanism may be 0.55 kg or more and 2.2 kg or less, preferably at least 1 kg. The speed-reduction ratio of the speed-reducing mechanism may be 1/60 or more (higher) and 1/15 or less (lower), e.g., between 1/60 and 1/15. The distance between a first side and a second side, which oppose each other, of the tip portion of the anvil may be 1 inch (2.54 cm) or more and 2.5 inches (6.35 cm) or less.

According to the above-mentioned configuration, the maximum fastening torque of the anvil can be made to be 3,200 N·m or more. It is noted that maximum fastening torque is the torque when fastening an object to be fastened and generally refers to the torque measured for a further fastening torque wrench or the like with respect to the object to be fastened (tightened) after it has been fastened (tightened). It is noted that it is not a method in which measuring is performed by loosening a nut or a bolt. Typically, maximum fastening torque is listed in the catalogs of respective manufacturers.

In one or more embodiments of the present teachings, an impact wrench may comprise: a brushless motor comprising a stator and a rotor, which rotates relative to the stator; an impact mechanism (e.g., a hammer), which is rotated by the rotor; an anvil, which is impacted by the impact mechanism; and one or more battery-mounting parts, on which one or more battery packs is (are respectively) mounted. The maximum fastening torque of the anvil may be 6,000 N·m or more.

According to the above-mentioned configuration, the anvil of the impact wrench can be driven (rotated) with or at a higher torque.

In one or more embodiments, the sum total of the rated voltage(s) of the battery pack(s) may be 72 V or more. The outer diameter of the stator may be 60 mm or more. The maximum output of the brushless motor may be 2,500 W or more. The rotational speed of the anvil may be 600 rpm or more and 2,400 rpm or less. The impact rate of the impact mechanism may be 900 ipm or more and 3,200 ipm or less. The weight (mass) of a hammer of the impact mechanism may be 1.1 kg or more and 4.4 kg or less. The speed-reduction ratio of the speed-reducing mechanism may be 1/60 or more (higher) and 1/15 or less (lower), i.e. between 1/60 and 1/15. The distance between a first side and a second side, which oppose each other, of the tip portion of the anvil may be 1 inch (2.54 cm) or more and 2.5 inches (6.35 cm) or less.

According to the above-mentioned configuration, the maximum fastening torque of the anvil can be made to be 6,000 N·m or more.

In one or more embodiments, an impact wrench may comprise: a brushless motor comprising a stator and a rotor, which rotates relative to the stator; an impact mechanism, which is rotated by the rotor; an anvil, which is impacted by the impact mechanism (e.g., a hammer); and one or more battery-mounting parts, on which one or more battery packs is (are respectively) mounted. The maximum fastening torque of the anvil may be 10,000 N·m or more.

According to the above-mentioned configuration, the anvil of the impact wrench can be driven (rotated) with or at a higher torque.

In one or more embodiments, the sum total of the rated voltage(s) of the battery pack(s) may be 144 V or more. The outer diameter of the stator may be 60 mm or more. The maximum output of the brushless motor may be 5,000 W or more. The rotational speed of the anvil may be 600 rpm or more and 2,400 rpm or less. The impact rate of the impact mechanism may be 900 ipm or more and 3,200 ipm or less. The weight (mass) of a hammer of the impact mechanism may be 2.2 kg or more and 3.8 kg or less. The speed-reduction ratio of the speed-reducing mechanism may be 1/60 or more (higher) and 1/15 or less (lower), i.e. between 1/60 and 1/15. The distance between a first side and a second side, which oppose each other, of the tip portion of the anvil may be 1 inch (2.54 cm) or more and 2.5 inches (6.35 cm) or less.

According to the above-mentioned configuration, the maximum fastening torque of the anvil can be made to be 10,000 N·m or more.

In one or more embodiments, the battery capacity of the battery pack may be 5 Ah or more.

In one or more embodiments, the electric current supplied to the brushless motor may be 80 A or less. The electric current supplied to the brushless motor may be 40 A or more and 60A or less.

In one or more embodiments, the impact energy per impact produced by the impact mechanism may be 95 J or more.

Embodiments according to the present disclosure are explained below, with reference to the drawings, but the present disclosure is not limited to the embodiments. Structural elements of the embodiments explained below can be combined where appropriate. In addition, there are also situations in which some of the structural elements are not used.

In the embodiments, positional relationships among parts are explained using the terms “left,” “right,” “front,” “rear,” “up,” and “down.” These terms indicate relative positions or directions, with the center of an impact wrench as the reference. A left-right direction, a front-rear direction, and an up-down direction are all mutually orthogonal.

It is noted that, in the embodiments, 1 N·m, which is a unit of torque, can be converted to 0.7376 ft·lb, and 1 ft·lb can be converted to 1.36 N·m.

### First Embodiment

A first embodiment will now be explained.

### Impact Wrench

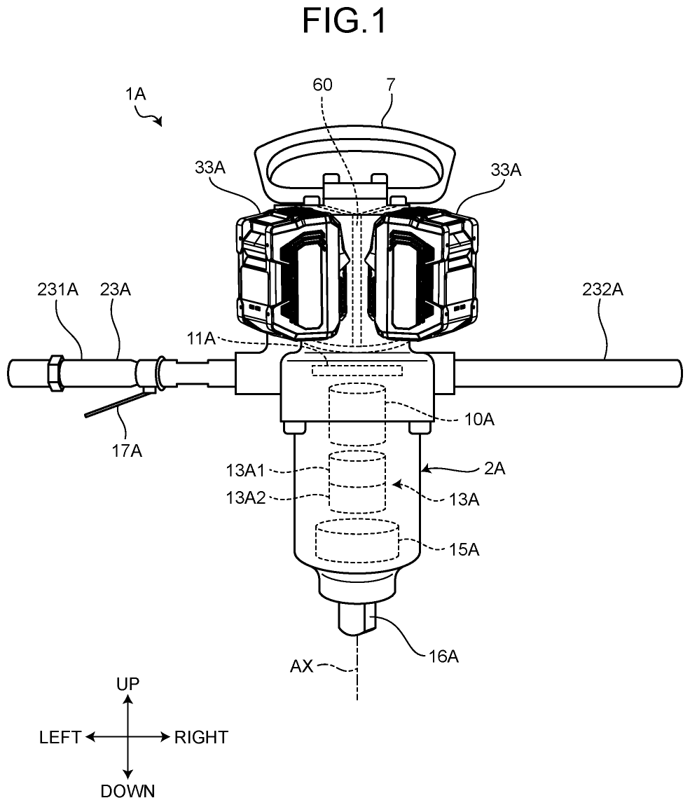

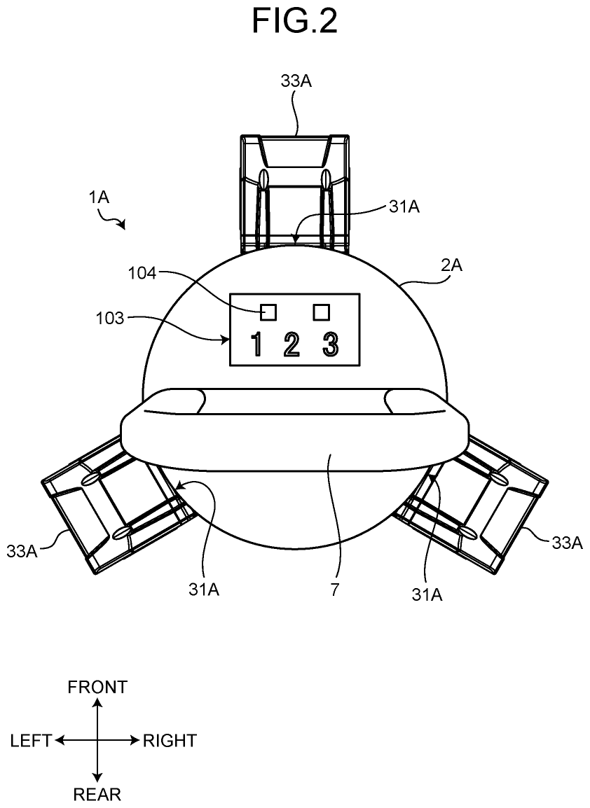

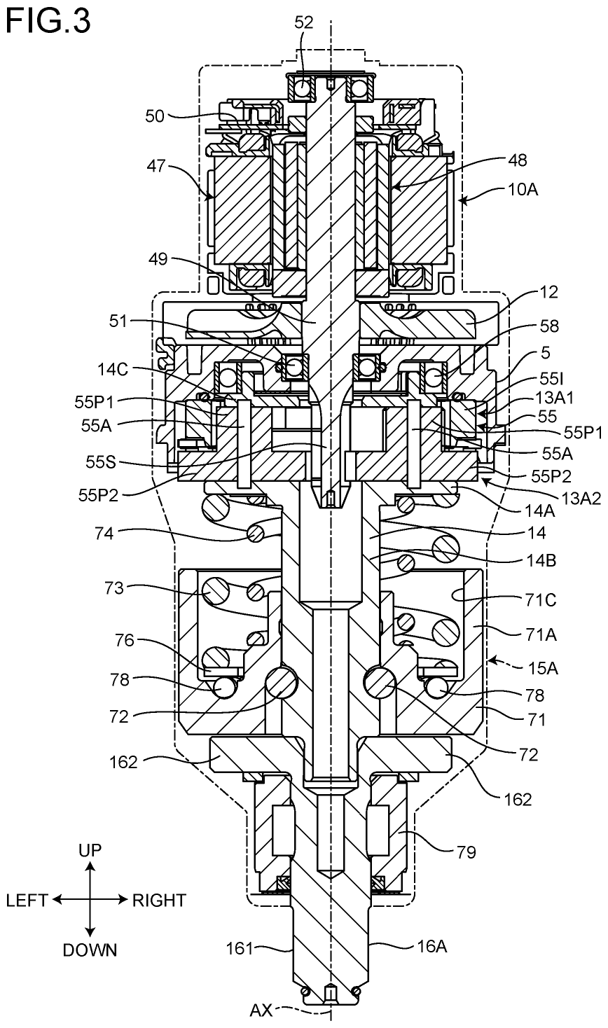

FIG. 1 is a front view that shows an impact wrench 1A according to the first embodiment. FIG. 2 is a top view that shows the impact wrench 1A according to the first embodiment. FIG. 3 is a cross-sectional view that shows a portion of the impact wrench 1A according to the first embodiment.

The impact wrench 1A comprises a main-body housing 2A, a handle 7, battery-mounting parts 31A, a motor 10A, a controller 11A, a fan 12, a speed-reducing mechanism (torque-increasing mechanism) 13A, a spindle 14, an impact mechanism 15A, an anvil 16A, and a trigger switch 17A.

The main-body housing 2A houses at least the motor 10A. In the present embodiment, the controller 11A, the fan 12, the speed-reducing mechanism 13A, the spindle 14, and the impact mechanism 15A are housed in the main-body housing 2A. In addition, a portion of the anvil 16A is also housed in the main-body housing 2A.

A grip part 23A is provided at an intermediate portion of the main-body housing 2A. The grip part 23A comprises a first grip part 231A, which protrudes leftward from the main-body housing 2A, and a second grip part 232A, which protrudes rightward from the main-body housing 2A. The grip part 23A is gripped by the user. The trigger switch 17A is disposed on the grip part 23A. In the present embodiment, the trigger switch 17A is disposed on the first grip part 231A. The first and second grip parts 231A, 232A are each preferably made of a metal and the second grip 232A is preferably undetachable from the main-body housing 2A.

The handle 7 is configured to be gripped by the user and preferably has a loop-shape. The handle 7 is provided at an upper portion of the main-body housing 2A. The loop-shape may be desirable in situations in which the impact wrench 1A is particularly heavy. In this case, a rope or other supporting material may be tied to, or looped around, the loop-shaped handle 7 and attached to or looped around a support structure above the impact wrench 1A so that the impact wrench 1A may be suspended above a workpiece, thereby reducing the weight that has to be borne by the user of the impact wrench 1A during a fastening operation.

The battery-mounting parts 31A are provided at upper portions of an outer-circumferential surface of the main-body housing 2A. In the present embodiment, three of the battery-mounting parts 31A are provided. The three battery-mounting parts 31A are disposed circumferentially spaced apart around the central axis of the main-body housing 2A, which extends in the up-down direction. In the present embodiment, the three battery-mounting parts 31A are disposed equispaced around the central axis of the main-body housing 2A.

Battery packs 33A are respectively mounted on the battery-mounting parts 31A. That is, one battery pack 33A is mounted on each one of the battery-mounting parts 31A. Each of the battery packs 33A is detachable from the corresponding battery-mounting part 31A.

Each of the battery-mounting parts 31A comprises terminals. By mounting each of the battery packs 33A on the corresponding battery-mounting parts 31A, battery terminals, which also may be called connection terminals, of each of the battery packs 33A are electrically connected to the corresponding terminals of the corresponding battery-mounting part 31A.

The battery packs 33A function as a power supply of the impact wrench 1A. Each of the battery packs 33A preferably comprises a secondary battery. In the present embodiment, each of the battery packs 33A preferably comprises a rechargeable lithium-ion battery (e.g., a plurality lithium-ion battery cells that are electrically connected to each other). When mounted on the battery-mounting parts 31A, the battery packs 33A can supply electric power to the impact wrench 1A. The motor 10A is driven using electric power supplied from the battery packs 33A. The controller 11A operates using electric power supplied from the battery packs 33A. Preferably, one or more elastic (cushioning) members 60 is (are respectively) disposed between the motor 10A and the one or more battery-mounting parts 31A. The elastic (cushioning) member(s) 60 serve(s) as vibration attenuation member(s) (vibration isolation member(s)) that absorb(s) and attenuate(s) vibrations generated by the motor 10A and/or by the impact mechanism 15A striking/impacting the anvil 16A. The elastic member(s) 60 may be, e.g., composed of an elastomeric material, such as, e.g., rubber (natural or synthetic) or polyurethane, or another material capable of effectively absorbing vibration. In any of the embodiments described herein, the elastic member(s) 60 may be in the form of a piece of elastomer member (e.g., flat shaped, block-shaped, gasket-shaped, etc.) and/or the elastic member(s) 60 may include one or more spring(s), e.g., in the form of compression springs, leaf springs, etc. The spring(s) may be composed of a metal, if desired. For example, one or more of the elastic (cushioning) member(s) may be formed, e.g., as disclosed in U.S. 2023/0026934 A1 and/or as springs, e.g., as disclosed in U.S. 2023/0121902 A1. The contents of U.S. 2023/0026934 A1 and U.S. 2023/0121902 A1 are incorporated herein by reference as if fully set forth herein.

The rated voltages of the three battery packs 33A are preferably equal to each other. The rated voltage(s) of each the battery packs 33A may be, e.g., 18 V or 36 V, or e.g., any voltage value between 18-36V. The outer shapes of the three battery packs 33A are preferably the same, and the dimensions of the three battery packs 33A are preferably the same. That is, the three battery packs 33A are of types that are equivalent to each other. However, it is, of course, possible to design the battery-mounting parts 31A such that battery packs having one or more of different rated voltages, different outer shapes, different dimensions, etc. may be mounted thereon.

The structures of the terminals of the three battery-mounting parts 31A are preferably equivalent to each other, and the sizes of the terminals of the three battery-mounting parts 31A are preferably equal to each other. But again, it is, of course, possible to design the battery-mounting parts 31A such that battery packs having one or more of different shapes and/or sizes, etc. may be mounted thereon.

The motor 10A functions as a motive power supply (source) of the impact wrench 1A. The motor 10A is preferably an inner-rotor-type DC brushless motor, although other types of motors may be utilized with the present teachings, such as an outer-rotor-type DC brushless motor. The motor 10A is housed in the main-body housing 2A.

The motor 10A comprises a stator 47, a rotor 48, and a rotor shaft 49. At least a portion of the rotor 48 is disposed in the interior of the stator 47. Thus, the stator 47 is disposed around the rotor 48. The rotor shaft 49 is fixed to the rotor 48. The rotor 48 is rotatable relative to the stator 47 about motor rotational axis AX, which extends in the up-down direction (Z-axis direction). The brushless motor 10A is preferably configured to output a motor torque of 2.0 N·m or more and 11.0 N·m or less, and to rotate the rotor 48 at a rotational speed of 3,000 rpm or more and 4,300 rpm or less.

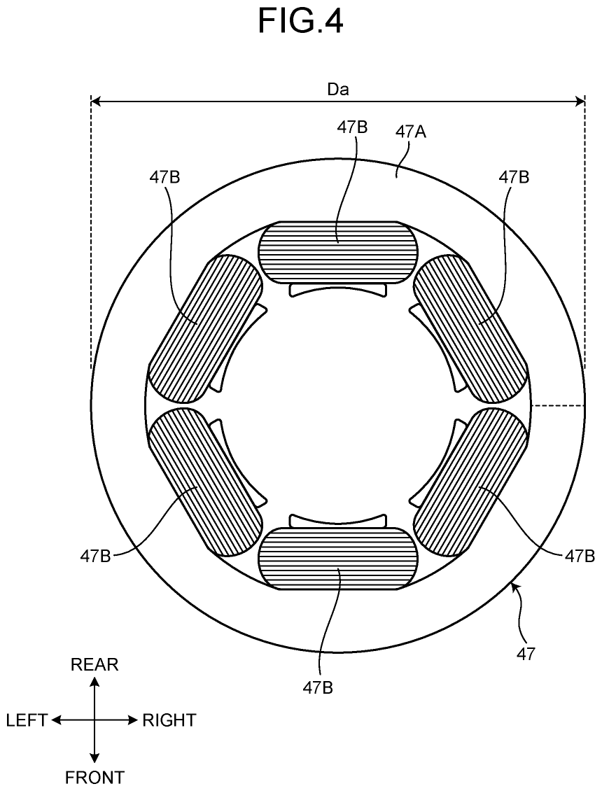

FIG. 4 schematically shows the stator 47 according to the first embodiment. The stator 47 comprises: a stator core 47A, which has a plurality of teeth; and coils 47B, which are wound through (around) insulators and respectively around the teeth of the stator core 47A. Pairs of the coils 47B are respectively connected to each other via a busbar unit (short-circuiting member).

The outer shape of the stator core 47A is substantially a circular shape. The stator core 47A is formed such that outer diameter Da of the stator core 47A is a stipulated value. The stator core 47A is composed of a plurality of stacked steel plates that are laminated together. The length of the stacked steel plates in a direction parallel to the rotational axis AX of the rotor is 24 mm or more.

As shown in FIG. 3, the rotor 48 rotates about rotational axis AX. Rotational axis AX extends in the up-down direction. The rotor 48 comprises a rotor core and one or more rotor magnets, which is (are) fixed to the rotor core. Preferably, the number of rotor magnets in the rotor core is greater than the number of teeth on the stator core 47A. The rotor magnets preferably (each) have a residual magnetic flux density of 1.32 T or more. In addition or in the alternative, the rotor magnets preferably have a coercive force of 971 kA/m or more.

A sensor board 50 is fixed to one of the insulators of the stator 47. The sensor board 50 detects the position of the rotor 48 in the rotational direction. The sensor board 50 comprises rotation-detection devices, which are supported on a ring-shaped circuit board. The rotation-detection devices detect the position of the rotor 48 in the rotational direction by detecting the position(s) of the rotor magnet(s) of the rotor 48.

The rotor shaft 49 is fixed to the rotor core of the rotor 48. The rotor 48 and the rotor shaft 49 rotate together about rotational axis AX.

The rotor shaft 49 is supported in a rotatable manner in (by) a first rotor bearing 51 and a second rotor bearing 52. The first rotor bearing 51 rotatable supports a lower portion of the rotor shaft 49, which protrudes more downward than a lower-end surface of the rotor 48. The second rotor bearing 52 rotatably supports an upper portion of the rotor shaft 49, which protrudes more upward than an upper-end surface of the rotor 48. The first rotor bearing 51 is held on a gear case 5.

A sun gear 55S is fixed to a lower-end portion of the rotor shaft 49. The sun gear 55S is coupled to at least a portion of the speed-reducing mechanism 13A, as will be further discussed below. The rotor shaft 49 is coupled to the speed-reducing mechanism 13A via the sun gear 55S.

The controller 11A outputs control signals, which control the energization of the motor 10A. The controller 11A comprises a circuit board, on which a plurality of electronic parts is installed. Illustrative examples of the electronic parts installed on the circuit board include: a processor, such as a CPU (central processing unit); nonvolatile memory, such as ROM (read-only memory) and storage; volatile memory, such as RAM (random-access memory); field-effect transistors (FETs: field-effect transistors); and resistors.

The controller 11A is disposed more upward than the motor 10A.

The fan 12 generates an airflow for cooling the motor 10A and the controller 11A. The fan 12 is disposed upward of the stator 47. The fan 12 is fixed to an upper portion of the rotor shaft 49. The fan 12 is disposed between the first rotor bearing 51 and the stator 47. The fan 12 and the rotor shaft 49 rotate together.

The speed-reducing mechanism 13A transmits, to the impact mechanism 15A, the rotational force of the motor 10A via the spindle 14. The speed-reducing mechanism 13A reduces the rotational speed of the rotor 48 and transmits that rotation to the impact mechanism 15A at an increased torque. The speed-reducing mechanism 13A couples the rotor shaft 49 and the spindle 14 to each other. The speed-reducing mechanism 13A causes the spindle 14 to rotate at a rotational speed that is lower than the rotational speed of the rotor shaft 49, but at a higher torque. The speed-reducing mechanism 13A comprises a planetary-gear mechanism 55, which is driven using the rotational force of the motor 10A.

The planetary-gear mechanism 55 comprises the sun gear 55S, planet gears 55P, and an internal gear 55I. A plurality of the planet gears 55P is provided. The planet gears 55P are disposed around the sun gear 55S. The internal gear 55I is disposed around the plurality of planet gears 55P. The planetary-gear mechanism 55 is housed in the gear case 5. As shown in FIGS. 1 and 3, the planetary-gear mechanism 13A includes a first-stage planetary gear set 13A1 and a second-stage planetary gear set 13A2, although it may be configured with only a single stage or with three or more stages. The first-stage and second stage planetary gear sets 13A1 and 13A2 rotate integrally. The sun gear 55S has an input axis (rotational axis AX), and the carrier 14A serves as the output of the planetary-gear mechanism 13A. Each of the planet gears 55P1 of the first-stage planetary gear set 13A1 meshes with the sun gear 55S. Each of the planet gears 55P2 of the second-stage planetary gear set 13A2 meshes with the internal gear 55I. The number N1 of teeth of each of the planet gears 55P1 of the first-stage planetary gear set 13A1 is greater than the number N2 of teeth of each of the planet gears 55P2 of the second-stage planetary gear set 13A2. When the sun gear 55S rotates, the planet gears 55P1 and 55P2 revolve around the sun gear 55S. Thus, the carrier 14A is rotated via the pins 55A, which are respectively disposed in the centers of the planet gears 55P1 and 55P2. In this configuration, the carrier 14A rotates at a rotational speed that is less than the rotational speed of the rotor 48 by the ratio N2/N1. The rotational output of the planetary-gear mechanism 13A (i.e. the carrier 14A) is transmitted to the impact mechanism 15A.

As was noted above, the sun gear 55S is rotatable about rotational axis AX, which extends in the up-down direction. When the rotor shaft 49 rotates, the sun gear 55S rotates.

As was noted above, each of the planet gears 55P1 meshes with the sun gear 55S. The planet gears 55P1, 55P2 are respectively supported in a rotatable manner on the spindle 14 via pins 55A. The carrier 14A and thus the spindle 14, which is fixed thereto, are rotated by the planet gears 55P2. The internal gear 55I comprises inner teeth (radially inward facing teeth), which mesh with the planet gears 55P2. The internal gear 55I is fixed to the gear case 5. A plurality of protruding portions is provided on an outer-circumferential surface of the internal gear 55I. The protruding portions of the internal gear 55I respectively fit (form fit, interference fit) into recessed portions provided (defined) in an inner-circumferential surface of the gear case 5. Thus, the internal gear 55I is always non-rotatable relative to the gear case 5.

When the motor 10A is driven (energized) and causes the rotor shaft 49 and the sun gear 55S to rotate, the planet gears 55P1, 55P2 revolve around the sun gear 55S. In particular, the planet gears 55P2 revolve around the sun gear 55S while meshing with the inner teeth of the internal gear 55I. When the planet gears 55P1, 55P2 revolve around the sun gear 55S, the spindle 14, which is connected to the planet gears 55P2 via the pins 55A and carrier 14A, rotates at a rotational speed that is lower than the rotational speed of the rotor shaft 49 and at a torque that is higher than the torque of the rotor shaft 49.

Thus, the spindle 14 is rotated by the rotational force of the motor 10A that is transmitted by (via) the speed-reducing mechanism 13A. The spindle 14 transmits to the impact mechanism 15A the rotational force of the motor 10A that was transmitted via the speed-reducing mechanism 13A. The spindle 14 is rotatable around output rotational axis AX. At least a portion of the spindle 14 is disposed downward of the speed-reducing mechanism 13A. The spindle 14 is disposed upward of the anvil 16A.

The spindle 14 comprises a flange portion 14A, a spindle-shaft portion 14B, and a protruding part 14C. The spindle-shaft portion 14B protrudes downward from the flange portion 14A. The protruding part 14C protrudes upward from the flange portion 14A.

The planet gears 55P2 are respectively supported in a rotatable manner on the flange portion 14A and the protruding part 14C via the pins 55A. The spindle 14 is supported in a rotatable manner on a spindle bearing 58. The spindle bearing 58 supports the protruding part 14C in a rotatable manner. The spindle bearing 58 is held on the gear case 5.

The impact mechanism 15A impacts the anvil 16A in the rotational direction around rotational axis AX. The impact mechanism 15A is disposed downward of the motor 10A. The impact mechanism 15A is rotated by the rotor 48 of the motor 10A. The impact mechanism 15A is rotatable around rotational axis AX. The rotational force of the motor 10A is transmitted to the impact mechanism 15A via the speed-reducing mechanism 13A and the spindle 14. The impact mechanism 15A impacts (strikes) the anvil 16A in the rotational direction using the rotational force of the spindle 14, which is rotated by the motor 10A.

The impact mechanism 15A comprises a hammer 71, balls 72, a first coil spring 73, a second coil spring 74, and a washer 76.

The hammer 71 is disposed downward of the speed-reducing mechanism 13A. The hammer 71 is disposed around the spindle-shaft portion 14B. The hammer 71 is held on the spindle-shaft portion 14B. The hammer 71 is rotated by the motor 10A. The balls 72 are disposed between the spindle-shaft portion 14B and the hammer 71. The hammer 71 comprises a tube-shaped hammer body 71A and hammer-projection portions, which are provided (defined) at a lower portion of the hammer body 71A. A ring-shaped recessed portion (annular recess) 71C is provided (defined) in an upper surface of the hammer body 71A. The recessed portion 71C recesses downward from an upper surface of the hammer body 71A.

The hammer 71 is rotated by the motor 10A. More specifically, the rotational force of the motor 10A is transmitted to the hammer 71 via the speed-reducing mechanism 13A and the spindle 14. The hammer 71 is rotatable, together with the spindle 14, using the rotational force of the spindle 14, which is rotated by the motor 10A. The hammer 71 and the spindle 14 each rotate about rotational axis AX.

The washer 76 is disposed in the interior of the recessed portion 71C. The washer 76 is supported on the hammer 71 via a plurality of balls 78. The balls 78 are disposed downward of the washer 76.

The first coil spring 73 is disposed around the spindle-shaft portion 14B. An upper-end portion of the first coil spring 73 is supported on the flange portion 14A. A lower-end portion of the first coil spring 73 is disposed in the interior of the recessed portion 71C and supported on the washer 76. The first coil spring 73 continuously generates an elastic force, which causes (urges) the hammer 71 to move downward.

The second coil spring 74 is disposed around the spindle-shaft portion 14B. The second coil spring 74 is disposed radially inward of the first coil spring 73. An upper-end portion of the second coil spring 74 is supported on the flange portion 14A. A lower-end portion of the second coil spring 74 is disposed in the interior of the recessed portion 71C and supported on the hammer 71. As the hammer 71 moves upward, the second coil spring 74 generates an elastic force, which causes (urges) the hammer 71 to move downward.

The balls 72 are made of a metal such as steel. The balls 72 are disposed between the spindle-shaft portion 14B and the hammer 71. The spindle 14 has a spindle groove, in which at least a portion of each of the balls 72 is disposed. The spindle groove is provided in a portion of an outer surface of the spindle-shaft portion 14B. The hammer 71 has a hammer groove, in which at least a portion of each of the balls 72 is disposed. The hammer groove is provided (defined) in a portion of an inner surface of the hammer 71. The balls 72 arc disposed between the spindle groove and the hammer groove. The balls 72 can roll along the inner side of the spindle groove and the inner side of the hammer groove. The hammer 71 is capable of moving along with the balls 72. The spindle 14 and the hammer 71 are capable of relative movement, within a movable range defined by the spindle groove and the hammer groove, in a direction parallel to rotational axis AX and in the rotational direction about rotational axis AX.

The anvil 16A rotates around rotational axis AX, which extends in the up-down direction. The anvil 16A is an output portion of the impact wrench 1A, which rotates using the rotational force of the motor 10A. At least a portion of the anvil 16A is disposed downward of the hammer 71. The anvil 16A is impacted (struck) in the rotational direction by the hammer 71 of the impact mechanism 15A, preferably at a rate of two impacts per 360° rotation of the hammer 71. A lower-end portion of the spindle-shaft portion 14B is disposed in an anvil-recessed portion, which is provided in an upper-end portion of the anvil 16A.

The anvil 16A comprises an anvil-shaft portion 161 and anvil-projection portions 162. The anvil-shaft portion 161 is disposed downward of the impact mechanism 15A. The anvil-projection portions 162 protrude radially outward of the anvil-shaft portion 161 from (at) an upper-end portion of the anvil-shaft portion 161. The anvil-projection portions 162 are impacted by the impact mechanism 15A in the rotational direction and thus rotated around rotational axis AX.

A lower-end portion of the anvil-shaft portion 161 is disposed downward of the main-body housing 2A through an opening in a lower portion of the main-body housing 2A. A socket, which serves as a tool accessory, is mounted on the lower-end portion of the anvil-shaft portion 161.

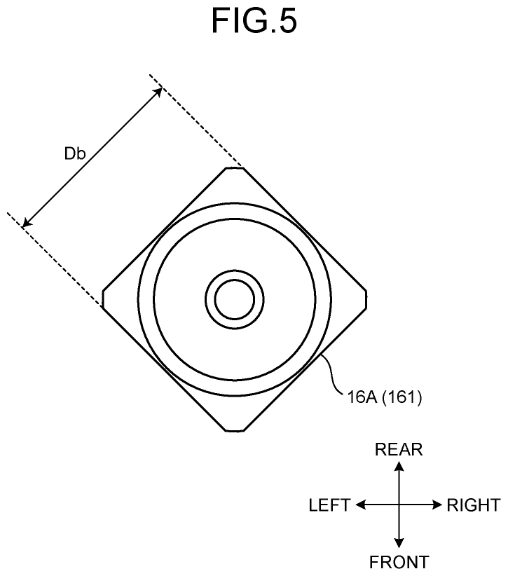

FIG. 5 schematically shows the anvil 16A according to the first embodiment. The socket is mounted on the lower-end portion (tip portion) of the anvil-shaft portion 161 of the anvil 16A. The tip portion of the anvil-shaft portion 161, on which the socket is mounted, is substantially a square-columnar shape. The anvil 16A is formed such that distance Db between the first side and the second side, which oppose each other across rotational axis AX, of the tip portion of the anvil-shaft portion 161 is a stipulated value. Distance Db is the distance between the first side and the second side within a plane orthogonal to rotational axis AX. Distance Db may be considered to be the length of one side of the anvil-shaft portion 161 within a plane orthogonal to rotational axis AX.

As shown in FIG. 3, the anvil 16A is supported in a rotatable manner in an anvil bearing 79. The anvil bearing 79 is disposed around the anvil-shaft portion 161. The anvil 16A is rotatable around rotational axis AX. In the present embodiment, the anvil bearing 79 is a slide bearing. The anvil bearing 79 has a tube shape. In the present embodiment, a sleeve is used as the anvil bearing 79. It is noted that the slide bearing may be formed by, for example, impregnating a tube-shaped porous-metal body, which is manufactured using a powder-metallurgy method, with a lubricating oil.

In a cross section orthogonal to rotational axis AX, the shape of the outer-circumferential surface of the portion of the anvil-shaft portion 161 that is supported on the anvil bearing 79 is circular. In a cross section orthogonal to rotational axis AX, the shape of the inner-circumferential surface of the anvil bearing 79 is circular.

The lower-end portion of the anvil-shaft portion 161 is disposed more downward than the main-body housing 2A through an opening in the lower-end portion of the main-body housing 2A. At least a portion of the anvil-shaft portion 161 is disposed in the interior of the opening in the lower-end portion of the main-body housing 2A.

The trigger switch 17A is manipulated (pressed, squeezed) by the user to drive the motor 10A. Driving of the motor 10A means that the coils 47B of the stator 47 are energized and thereby the rotor 48 rotates. The trigger switch 17A is provided on the first grip part 231A. The motor 10A is driven by manipulating (pressing, squeezing) the trigger switch 17A such that it approaches the first grip part 231A. The drive of the motor 10A is stopped by releasing the manipulation of the trigger switch 17A.

As shown in FIG. 2, a switch panel 103 is disposed on the upper surface of the main-body housing 2A. The rotational speed of the motor 10A may be changed by manipulating switches 104, which are provided on the switch panel 103.

### Operation of Impact Wrench

Next, the operation of the impact wrench 1A will be explained. For example, when fastening work is to be performed on a work object, the socket to be used in the fastening work is mounted on the lower-end portion of the anvil 16A. After the socket has been mounted on the anvil 16A, the user grips the grip part 23A with both hands and manipulates the trigger switch 17A such that the trigger switch 17A approaches the first grip part 231A. When the trigger switch 17A is manipulated, electric power is supplied from the battery packs 33A to the motor 10A, and thereby the motor 10A is driven. The rotor 48 and the rotor shaft 49 are thus rotated by the motor 10A. When the rotor shaft 49 rotates, the rotational force of the rotor shaft 49 is transmitted to the planet gears 55P via the sun gear 55S. In the state in which the planet gears 55P mesh with the inner teeth of the internal gear 55I, the planet gears 55P revolve around the sun gear 55S while rotating. The planet gears 55P are supported in a rotatable manner on the spindle 14 via the pins 55A. Owing to the revolving of the planet gears 55P, the spindle 14 rotates at a rotational speed that is lower than the rotational speed of the rotor shaft 49.

When the spindle 14 rotates in the state in which the hammer-projection portions and the anvil-projection portions 162 are in contact with each other, the anvil 16A rotates together with the hammer 71 and the spindle 14. Owing to the rotation of the anvil 16A, the fastening work advances.

In the situation in which, owing to the advancement of the fastening work, a load that is greater than or equal to a prescribed value acts on the anvil 16A, the rotation of the anvil 16A and the hammer 71 momentarily stops. Then, as the spindle 14 continues to rotate while the rotation of the hammer 71 is stopped, the hammer 71 moves upward. When the hammer 71 moves upward relative to the spindle 14, the hammer-projection portions no longer contact the anvil-projection portions 162. The upwardly-moved hammer 71 then moves downward while rotating owing to the elastic force of the first coil spring 73 and the second coil spring 74. When the hammer 71 has moved downward again while rotating, the anvil 16A is impacted in the rotational direction by the hammer 71. Thereby, the anvil 16A rotates about output rotational axis AX with (at) higher torque. Consequently, a bolt or nut can be fastened with (at) higher torque.

In the present embodiment, the maximum fastening torque of the anvil 16A is 3,200 N·m or more. The maximum fastening torque of the anvil 16A may be 3,200 N·m or more and less than 6,000 N·m. Preferably, the impact wrench 1A is configured to convert continuous torque input from the brushless motor 10A into the maximum fastening torque of the anvil of 3,200 N·m or more without exceeding 80 A of current drawn by the brushless motor 10A.

The specifications of the impact wrench 1A according to the present embodiment are as below.

### Specifications

Maximum fastening torque of anvil: 3,200 N·m
Sum total of rated voltages (18V each) of the three battery packs: 54 V
Outer diameter Da of stator core: 50 mm
Maximum output of motor: 1,250 W
Rotational speed of anvil (during no-load): 1,200 rpm
Impact rate of impact mechanism: 1,800 ipm
Speed-reduction ratio of speed-reducing mechanism: 1/30
Weight (mass) of hammer: 1.1 kg
Distance Db between first side and second side of tip portion of anvil: 1 inch (2.54 cm)
External dimensions of impact wrench when battery pack(s) is (are) not mounted: 680 mm (front-rear direction)×680 mm (left-right direction)×240 mm (up-down direction)
Weight (mass) of impact wrench when battery pack(s) is (are) not mounted: 10 kg

One or more battery packs having a rated voltage of 36 V (maximum of 40 V) should be mounted on the impact wrench 1A such that the sum total of the rated voltages of the battery packs is 36 V or more. It is noted that two or more battery packs, each having a rated voltage of 18 V, may be mounted on the impact wrench 1A.

### Effects

In the first embodiment as explained above, the impact wrench 1A comprises: the motor 10A, which is a brushless motor, comprising the rotor 48 and the stator 47, which is disposed around the rotor 48; the impact mechanism 15A, which is rotated by the rotor 48; the anvil 16A, which is impacted by the impact mechanism 15A; and the battery-mounting parts 31A, on which the battery packs 33A are mounted. The maximum fastening torque of the anvil 16A is 3,200 N·m or more.

According to the above-mentioned configuration, the anvil 16A of the impact wrench 1A can be driven with (at) relatively high torque.

In the first embodiment, the sum total of the rated voltages of the battery packs 33A is 36 V or more. Outer diameter Da of the stator core 47A is 50 mm or more. The maximum output of the motor 10A is 1,250 W or more. The rotational speed of the anvil 16A after being reduced by the speed-reducing mechanism 13A is 1,200 rpm. The impact rate of the impact mechanism 15A is 1,800 ipm. The weight (mass) of the hammer 71 of the impact mechanism 15A is 1.1 kg. The speed-reduction ratio of the speed-reducing mechanism 13A is 1/30. The distance Db between the first side and the second side, which oppose each other, of the tip portion of the anvil 16A is 1 inch (2.5 cm).

According to the above-mentioned configuration, the maximum fastening torque of the anvil 16A can be made to be 3,200 N·m or more.

### Second Embodiment

A second embodiment will now be explained. In the explanation below, structural elements that are identical or equivalent to those in the embodiment described above are assigned the same symbols, and explanations of those structural elements are abbreviated or omitted.

### Impact Wrench

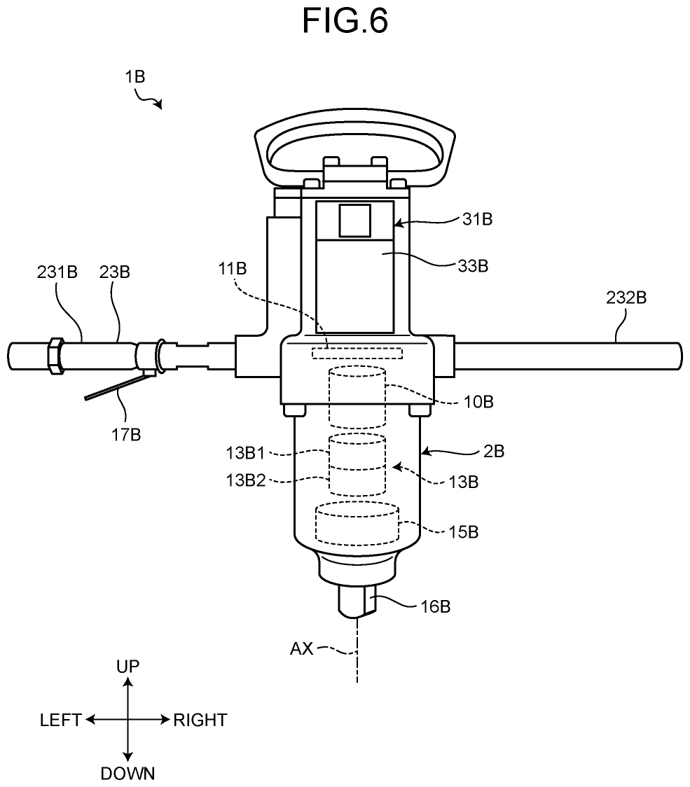

FIG. 6 is a front view that shows an impact wrench 1B according to the second embodiment. The impact wrench 1B according to the present embodiment is a modified example of the impact wrench 1A according to the first embodiment described above.

The impact wrench 1B comprises: a main-body housing 2B; a battery-mounting part 31B; a motor 10B; a controller 11B; the speed-reducing mechanism 13B (which includes a first-stage planetary gear set 13B1 and a second-stage planetary gear set 13B2, similar to the first embodiment described above); the impact mechanism 15A; an anvil 16B; a grip part 23B comprising a first grip part 231B and a second grip part 232B; and a trigger switch 17B.

The battery-mounting part 31B is provided at an upper portion of the outer-circumferential surface of the main-body housing 2B. In the present embodiment, one battery-mounting part 31B is provided.

A battery pack 33B is mounted on the battery-mounting part 31B. The battery pack 33B is detachable from the battery-mounting part 31B.

The rated voltage of the battery pack 33B may be 18 V, may be 36 V, or may be 72 V, or any value between 18-72V.

In the second embodiment, the maximum fastening torque of the anvil 16B is 6,000 N·m or more. The maximum fastening torque of the anvil 16B may be 6,000 N·m or more and less than 10,000 N·m.

The specifications of the impact wrench 1B according to the present embodiment are as below.

### Specifications

Maximum fastening torque of anvil: 6,000 N·m
Rated voltage of battery pack: 72 V
Outer diameter Da of stator core: 60 mm
Maximum output of motor: 2,500 W
Rotational speed of anvil (during no-load): 1,200 rpm
Impact rate of impact mechanism: 1,800 ipm
Speed-reduction ratio of speed-reducing mechanism: 1/30
Weight (mass) of hammer: 2.2 kg
Distance Db between first side and second side of tip portion of anvil: ½inch (1.27 cm)
External dimensions of impact wrench when battery pack is not mounted: 680 mm (front-rear direction)×680 mm (left-right direction)×240 mm (up-down direction)
Weight (mass) of impact wrench when battery pack is not mounted: 20 kg

One or more battery packs having a rated voltage of 72 V (maximum of 80 V) should be mounted on the impact wrench 1B such that the sum total of the rated voltage(s) of the battery pack(s) is 72 V or more. It is noted that two or more battery packs, each having a rated voltage of 36 V, may be mounted on the impact wrench 1B, or four or more battery packs, each having a rated voltage of 18 V, may be mounted on the impact wrench 1B.

### Effects

In the second embodiment as explained above, the maximum fastening torque of the anvil 16B of the impact wrench 1B is 6,000 N·m or more.

According to the above-mentioned configuration, the anvil 16B of the impact wrench 1B can be driven at relatively high torque.

In the second embodiment, the sum total of the rated voltage(s) of the battery pack(s) 33B is 72 V or more. Outer diameter Db of the stator core 47A is 60 mm or more. The maximum output of the motor 10B is 2,500 W or more. The rotational speed of the anvil 16B after being reduced by a speed-reducing mechanism 13B is 1,200 rpm. The impact rate of an impact mechanism 15B is 1,800 ipm. The weight (mass) of the hammer of the impact mechanism 15B is 2.2 kg. The speed-reduction ratio of the speed-reducing mechanism 13B is 1/30. The distance Db between the first side and the second side, which oppose each other, of the tip portion of the anvil 16B is ½inch (1.27 cm) or more and 1 inch (2.54 cm) or less.

According to the above-mentioned configuration, the maximum fastening torque of the anvil can be made to be 6,000 N·m or more.

### Third Embodiment

A third embodiment will now be explained. In the explanation below, structural elements that are identical or equivalent to those in the embodiment described above are assigned the same symbols, and explanations of those structural elements are abbreviated or omitted.

### Impact Wrench

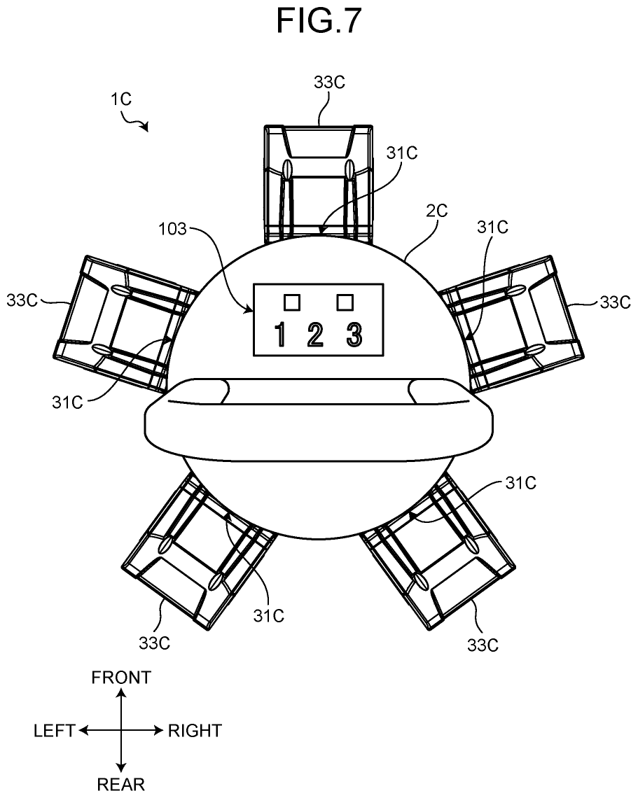

FIG. 7 is a top view that shows an impact wrench 1C according to the third embodiment. The impact wrench 1C according to the present embodiment is a modified example of the impact wrench 1A according to the first embodiment described above.

The impact wrench 1C comprises a main-body housing 2C and battery-mounting parts 31C, which are provided on the outer-circumferential surface of the main-body housing 2C. The switch panel 103 is disposed on the upper surface of the main-body housing 2C.

In the third embodiment, five battery-mounting parts 31C are provided. The five battery-mounting parts 31C are disposed spaced apart circumferentially around the central axis of the main-body housing 2C, which extends in the up-down direction. In the present embodiment, the five battery-mounting parts 31C are disposed equispaced around the central axis of the main-body housing 2C.

Battery packs 33C are respectively mounted on the battery-mounting parts 31C. That is, one battery pack 33C is mounted on each one of the battery-mounting parts 31C. Each of the battery packs 33C is detachable from the corresponding battery-mounting part 31C.

The rated voltages of the five battery packs 33C are preferably equal to each other. The rated voltages of the battery packs 33C may be 18 V, may be 36 V, or may be 72 V, or any voltage value between 18-72V. The outer shapes of the three battery packs 33C are preferably the same, and the dimensions of the five battery packs 33C are preferably the same. That is, the five battery packs 33C are preferably of types that are equivalent to each other.

The structures of the terminals of the five battery-mounting parts 31C are equivalent to each other, and the sizes of the terminals of the five battery-mounting parts 31C are equal to each other.

In the present embodiment, the maximum fastening torque of the anvil of the impact wrench 1C is 10,000 N·m or more.

The specifications of the impact wrench 1C according to the present embodiment are as below.

### Specifications

Maximum fastening torque of anvil: 10,000 N·m
Sum total of rated voltages of battery pack(s): at least 144 V
Outer diameter Da of stator core: 60 mm
Maximum output of motor: 5,000 W
Rotational speed of anvil (during no-load): 1,200 rpm
Impact rate of impact mechanism: 1,800 rpm
Speed-reduction ratio of speed-reducing mechanism: 1/30
Weight (mass) of hammer: 4.4 kg
Distance Db between first side and second side of tip portion of anvil: ½inch (1.27 cm)
External dimensions of impact wrench when battery pack(s) is (are) not mounted: 680 mm (front-rear direction)×680 mm (left-right direction)×240 mm (up-down direction)
Weight (mass) of impact wrench when battery pack(s) is (are) not mounted: 40 kg

Two or more battery packs having a rated voltage of 72 V (maximum of 80 V) should be mounted on the impact wrench 1C such that the sum total of the rated voltages of the battery packs is 144 V or more. It is noted that four or more battery packs, each having a rated voltage of 36 V, may be mounted on the impact wrench 1C, or eight or more battery packs, each having a rated voltage of 18 V, may be mounted on the impact wrench 1C.

### Effects

In the embodiment as explained above, the maximum fastening torque of the anvil of the impact wrench 1C is 10,000 N·m or more.

According to the above-mentioned configuration, the anvil of the impact wrench 1C can be driven at relatively high torque.

In the third embodiment, the sum total of the rated voltages of the battery packs 33C is 144 V or more. Outer diameter of the stator core 47A is 60 mm or more. The maximum output of the motor is 5,000 W or more. The rotational speed of the anvil after being reduced by a speed-reducing mechanism is 1,200 rpm. The impact rate of an impact mechanism is 1,800 ipm. The weight (mass) of the hammer of the impact mechanism is 4.4 kg. The speed-reduction ratio of the speed-reducing mechanism is 1/30. The distance Db between the first side and the second side, which oppose each other, of the tip portion of the anvil is ½inch (1.27 cm) or more and 2 inches (5.08 cm) or less.

According to the above-mentioned configuration, the maximum fastening torque of the anvil can be made to be 10,000 N·m or more.

### Fourth Embodiment

A fourth embodiment will now be explained. In the explanation below, structural elements that are identical or equivalent to those in the embodiment described above are assigned the same symbols, and explanations of those structural elements are abbreviated or omitted.

### Impact Wrench

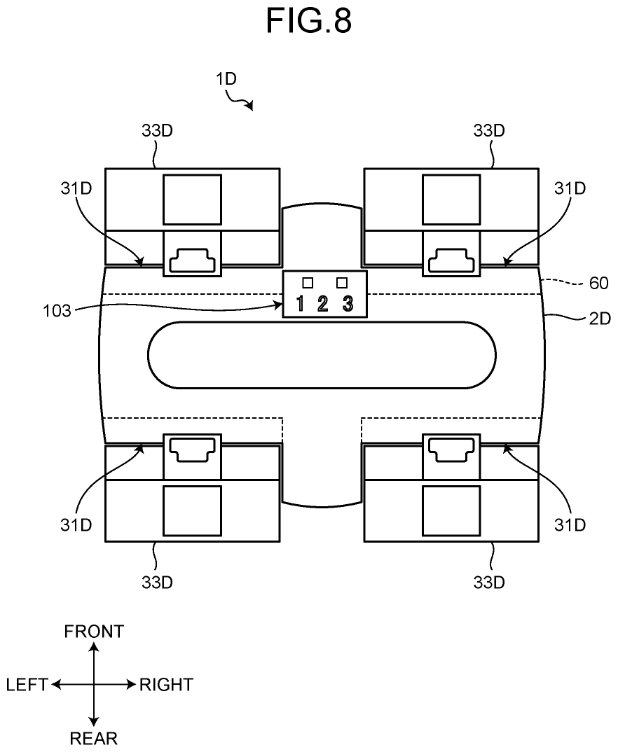

FIG. 8 is a top view that shows an impact wrench 1D according to the fourth embodiment. The impact wrench 1D according to the present embodiment is a modified example of the impact wrench 1A according to the first embodiment described above.

The impact wrench 1D comprises a main-body housing 2D and battery-mounting parts 31D, which are provided on the main-body housing 2D. The switch panel 103 is disposed on the upper surface of the main-body housing 2D.

In the fourth embodiment, four of the battery-mounting parts 31D are provided. Two of the battery-mounting parts 31D are provided at (on) a front portion of the main-body housing 2D, and two of the battery-mounting parts 31D are provided at (on) a rear portion of the main-body housing 2D. Similar to the first embodiment described above, one or more elastic members 60 is (are respectively) disposed between the motor and the battery-mounting parts 31D to serve as vibration attenuation member(s) (vibration isolation member(s)).

Battery packs 33D are respectively mounted on the battery-mounting parts 31D. That is, one battery pack 33D is mounted on each one of the battery-mounting parts 31D. Each of the battery packs 33D is detachable from the corresponding battery-mounting part 31D.

The rated voltages of the four battery packs 33D are preferably equal to each other. The outer shapes of the four battery packs 33D are preferably the same, and the dimensions of the four battery packs 33C are preferably the same. That is, the four battery packs 33D are preferably of types that are equivalent to each other.

The structures of the terminals of the four battery-mounting parts 31D are preferably equivalent to each other, and the sizes of the terminals of the four battery-mounting parts 31D are preferably equal to each other.

The specifications of the impact wrench 1D according to the present embodiment are as below.

### Specifications

Maximum fastening torque of anvil: 32,000 N·m
Sum total of rated voltages of battery pack(s): at least 320 V
Outer diameter Da of stator core: 80 mm
Maximum output of motor: 5,000 W
Rotational speed of anvil (during no-load): 570 rpm
Impact rate of impact mechanism: 750 ipm
Speed-reduction ratio of speed-reducing mechanism: 1/52.6
Weight (mass) of hammer: 34 kg
Distance Db between first side and second side of tip portion of anvil: 2.5 inches (6.35 cm)
External dimensions of impact wrench when battery pack(s) is (are) not mounted: 680 mm (front-rear direction)×680 mm (left-right direction)×240 mm (up-down direction)
Weight (mass) of impact wrench when battery pack(s) is (are) not mounted: 100 kg

Four or more of the battery packs, each having a rated voltage of 80 V max, may be mounted on the impact wrench 1D such that the sum total of the rated voltages of the battery packs is 320 V or more.

### Fifth Embodiment

A fifth embodiment will now be explained. In the explanation below, structural elements that are identical or equivalent to those in the embodiment described above are assigned the same symbols, and explanations of those structural elements are abbreviated or omitted.

### Impact Wrench

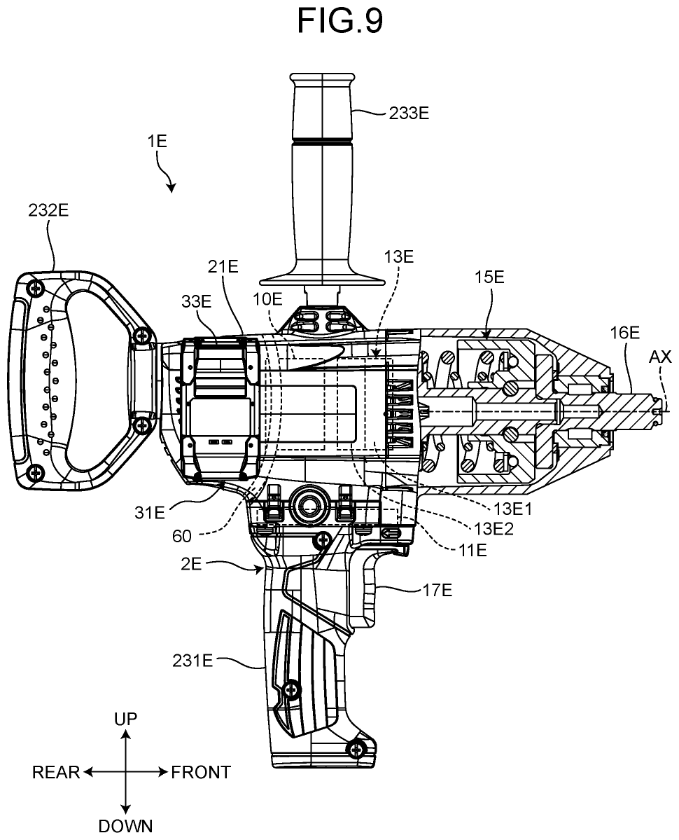

FIG. 9 is a side view that shows an impact wrench 1E according to the fifth embodiment.

The impact wrench 1E comprises a main-body housing 2E, a motor 10E, a controller 11E, a speed-reducing mechanism 13E (which includes a first-stage planetary gear set 13E1 and a second-stage planetary gear set 13E2, similar to the first embodiment described above), an impact mechanism 15E, an anvil 16E, and a trigger switch 17E.

The main-body housing 2E comprises: a main-body part 21E, which houses the motor 10E; and a grip part 231E, which extends downward from a lower portion of the main-body part 21E. The trigger switch 17E is disposed at a front portion of the grip part 231E. In addition, a first handle 232E is provided at a rear portion of the main-body part 21E, and a second handle 233E is provided at an upper portion of the main-body part 21E.

The controller 11E is disposed at (in) an upper portion of the grip part 231E. The speed-reducing mechanism 13E is disposed forward of the motor 10E in the main-body part 21E. The impact mechanism 15E is disposed forward of the speed-reducing mechanism 13E. In the fifth embodiment, rotational axis AX extends in the front-rear direction. The rotor of the motor 10E rotates about rotational axis AX. The impact mechanism 15E impacts the anvil 16E in the rotational direction and rotates the anvil 16E around rotational axis AX. The anvil 16E rotates about rotational axis AX.

In the fifth embodiment, one battery pack 33E is provided. A battery-mounting part 31E is provided on the main-body part 21E. In the present embodiment, the battery-mounting part 31E is provided at (on) a right portion of the main-body part 21E. It is noted that the battery-mounting part 31E may be provided at (on) a left portion of the main- body part 21E. Similar to the first embodiment described above, one or more elastic members 60 is (are respectively) disposed between the motor 10E and the battery-mounting part 31E to serve as vibration attenuation member(s) (vibration isolation member(s)).

The specifications of the impact wrench 1E according to the present embodiment are as below.

### Specifications

Maximum fastening torque of anvil: 7,500 N·m
Rated voltage of battery pack: 72 V
Outer diameter Da of stator core: 80 mm
Maximum output of motor: 7,500 W
Rotational speed of anvil (during no-load): 761 rpm
Impact rate of impact mechanism: 1,000 rpm
Speed-reduction ratio of speed-reducing mechanism: 1/39.4
Weight (mass) of hammer: 4.5 kg
Distance Db between first side and second side of tip portion of anvil: 1.5 inches (3.81 cm)
External dimensions of impact wrench when battery pack is not mounted: 340 mm (front-rear direction)×160 mm (left-right direction)×401 mm (up-down direction)
Weight (mass) of impact wrench when battery pack is not mounted: 30 kg

One or more of the battery packs, each having a rated voltage of 72 V, may be mounted on the impact wrench 1E such that the sum total of the rated voltage(s) of the battery pack(s) is 72 V or more.

### Sixth Embodiment

A sixth embodiment will now be explained. In the explanation below, structural elements that are identical or equivalent to those in the embodiment described above are assigned the same symbols, and explanations of those structural elements are abbreviated or omitted.

### Impact Wrench

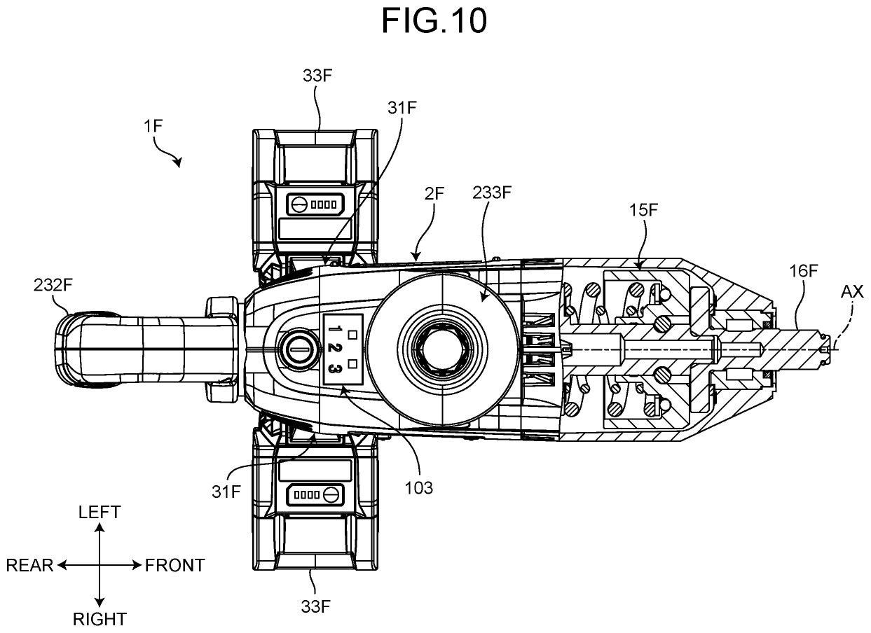

FIG. 10 is a top view that shows an impact wrench IF according to the sixth embodiment. The impact wrench IF according to the present embodiment is a modified example of the impact wrench 1E according to the fifth embodiment described above.

The impact wrench IF comprises a main-body housing 2F, an impact mechanism 15F, an anvil 16F, a first handle part 232F, and a second handle part 233F. The switch panel 103 is disposed on the upper surface of the main-body housing 2F.

In the present embodiment, two battery-mounting parts 31F are provided. One of the battery-mounting parts 31F is provided at (on) a left portion of the main-body housing 2F, and the other battery-mounting part 31F is provided at (on) a right portion of the main-body housing 2F. One battery pack 33F is mounted on each battery-mounting part 31F.

For example, by mounting two battery packs 33F, each having a rated voltage of 36 V or more, on two battery-mounting parts 31F, respectively, such that the sum total of the rated voltages of the battery packs is 72 V or more, specifications the same as those of the impact wrench 1E explained in the fifth embodiment described above can be achieved.

In addition, two battery packs 33F, each having a rated voltage of 18 V, may be mounted on two battery-mounting parts 31F, respectively, such that the sum total of the rated voltages of the battery packs is 36 V or more. In addition, the specifications of the impact wrench 1F may be as below.

### Specifications

Maximum fastening torque of anvil: 4,000 N·m
Sum total of rated voltages of battery pack(s): 36 V
Outer diameter Da of stator core: 80 mm
Maximum output of motor: 4,000 W
Rotational speed of anvil (during no-load): 685 rpm
Impact rate of impact mechanism: 900 rpm
Speed-reduction ratio of speed-reducing mechanism: 1/52.6
Weight (mass) of hammer: 2.3 kg
Distance Db between first side and second side of tip portion of anvil: 1 inch (2.54 cm)
External dimensions of impact wrench when battery pack(s) is (are) not mounted: 340 mm (front-rear direction)×160 mm (left-right direction)×401 mm (up-down direction)
Weight (mass) of impact wrench when battery pack(s) is (are) not mounted: 15 kg

### Seventh Embodiment

A seventh embodiment will now be explained. In the explanation below, structural elements that are identical or equivalent to those in the embodiment described above are assigned the same symbols, and explanations of those structural elements are abbreviated or omitted.

### Impact Wrench

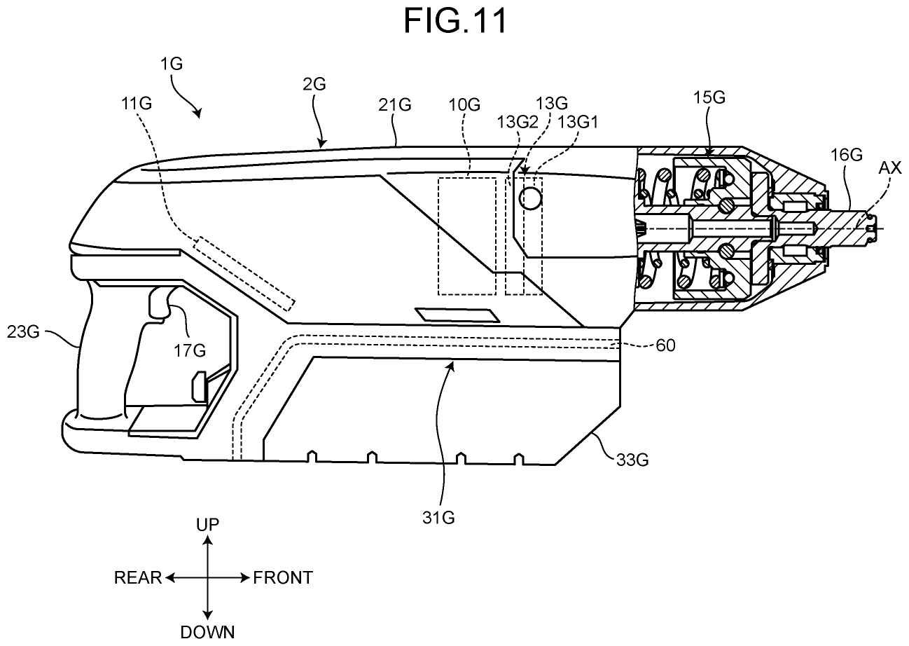

FIG. 11 is a side view that shows an impact wrench 1G according to the seventh embodiment.

The impact wrench 1G comprises a main-body housing 2G, a motor 10G, a controller 11G, a speed-reducing mechanism 13G (which includes a first-stage planetary gear set 13G1 and a second-stage planetary gear set 13G2, similar to the first embodiment described above), an impact mechanism 15G, an anvil 16G, and a trigger switch 17G. The switch panel 103 may be disposed on the upper surface of the main-body housing 2G.

The main-body housing 2G comprises: a main-body part 21G, which houses the motor 10G; and a grip part 23G, which is provided at a rear portion of the main-body part 21G. The trigger switch 17G is disposed at a front portion of the grip part 23G.

The controller 11G is disposed at (in) a rear portion of the main-body part 21G. The speed-reducing mechanism 13G is disposed forward of the motor 10G in the main-body part 21G. The impact mechanism 15G is disposed forward of the speed-reducing mechanism 13G. In the present embodiment, rotational axis AX extends in the front-rear direction. The rotor of the motor 10G rotates about rotational axis AX. The impact mechanism 15G impacts the anvil 16G in the rotational direction and thus rotates the anvil 16G around rotational axis AX. The anvil 16G rotates about rotational axis AX.

In the present embodiment, one battery pack 33G is provided. A battery-mounting part 31G is provided at (on) a lower portion of the main-body part 21G. Similar to the first embodiment described above, one or more elastic members 60 is (are respectively) disposed between the motor 10G and the battery-mounting part 31G to serve as vibration attenuation member(s) (vibration isolation member(s)).

The specifications of the impact wrench 1G according to the present embodiment are as below.

### Specifications

Maximum fastening torque of anvil: 7,500 N·m
Rated voltage of battery pack: 72 V
Outer diameter Da of stator core: 80 mm
Maximum output of motor: 7,500 W
Rotational speed of anvil (during no-load): 761 rpm
Impact rate of impact mechanism: 1,000 ipm
Speed-reduction ratio of speed-reducing mechanism: 1/39.4
Weight (mass) of hammer: 4.5 kg
Distance Db between first side and second side of tip portion of anvil: 1.5 inches
External dimensions of impact wrench when battery pack is not mounted: 542 mm (front-rear direction)×122 mm (left-right direction)×236 mm (up-down direction)
Weight (mass) of impact wrench when battery pack is not mounted: 30 kg

One or more of the battery packs, each having a rated voltage of 72 V, may be mounted on the impact wrench 1G such that the sum total of the rated voltages of the battery packs is 72 V or more.

### Eighth Embodiment

An eighth embodiment will now be explained. In the explanation below, structural elements that are identical or equivalent to those in the embodiment described above are assigned the same symbols, and explanations of those structural elements are abbreviated or omitted.

### Impact Wrench

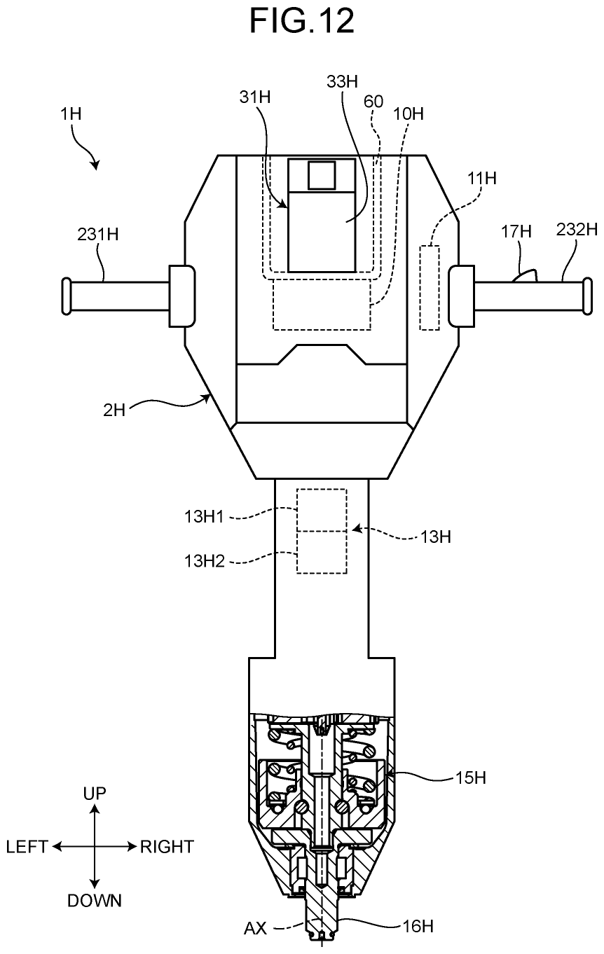

FIG. 12 is a front view that shows an impact wrench 1H according to the eighth embodiment.

The impact wrench 1H comprises a main-body housing 2H, a first grip part 231H, a second grip part 232H, a motor 10H, a controller 11H, a speed-reducing mechanism 13H (which includes a first-stage planetary gear set 13H1 and a second-stage planetary gear set 13H2, similar to the first embodiment described above), an impact mechanism 15H, an anvil 16H, and a trigger switch 17H.

The motor 10H is housed in the main-body housing 2H. The first grip part 231H protrudes leftward from the main-body housing 2H. The second grip part 232H protrudes rightward from the main-body housing 2H. The trigger switch 17H is disposed on the second grip part 232H.

The controller 11H is housed in a right portion of the main-body housing 2H. The speed-reducing mechanism 13H is disposed downward of the motor 10H. The impact mechanism 15H is disposed downward of the speed-reducing mechanism 13H. A tip portion of the anvil 16H protrudes downward from a lower-end portion of the main-body housing 2H. In the eighth embodiment, rotational axis AX extends in the up-down direction. The rotor of the motor 10H rotates around rotational axis AX. The impact mechanism 15H impacts the anvil 16H in the rotational direction around rotational axis AX. The anvil 16H rotates around rotational axis AX.

In the present embodiment, one battery pack 33H is provided. A battery-mounting part 31H is provided at (on) an upper portion of the main-body housing 2H. Similar to the first embodiment described above, one or more elastic members 60 is (are respectively) disposed between the motor 10H and the battery-mounting part 31H to serve as vibration attenuation member(s) (vibration isolation member(s)).

The specifications of the impact wrench 1H according to the present embodiment are as below.

### Specifications

Maximum fastening torque of anvil: 7,500 N·m
Rated voltage of battery pack: 72 V
Outer diameter Da of stator core: 80 mm
Maximum output of motor: 7,500 W
Rotational speed of anvil (during no-load): 761 rpm
Impact rate of impact mechanism: 1,000 ipm
Speed-reduction ratio of speed-reducing mechanism: 1/39.4
Weight (mass) of hammer: 4.5 kg
Distance Db between first side and second side of tip portion of anvil: 1.5 inches (3.81 cm)
External dimensions of impact wrench when battery pack is not mounted: 219 mm (front-rear direction)×540 mm (left-right direction)×854 mm (up-down direction)
Weight (mass) of impact wrench when battery pack is not mounted: 30 kg

One or more of the battery packs, each having a rated voltage of 72 V, may be mounted on the impact wrench 1H such that the sum total of the rated voltages of the battery packs is 72 V or more.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved impact wrenches and similar power tools.

Moreover, combinations of features and steps disclosed in the above detailed description may not be necessary to practice the invention in the broadest sense, and are instead taught merely to particularly describe representative examples of the invention.

Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1A Impact wrench
1B Impact wrench
1C Impact wrench
1D Impact wrench
1E Impact wrench
1F Impact wrench
1G Impact wrench
1H Impact wrench
2A Main-body housing
2B Main-body housing
2C Main-body housing
2D Main-body housing
2E Main-body housing
2F Main-body housing
2G Main-body housing
2H Main-body housing
5 Gear case
7 Handle
10A Motor
10B Motor
10E Motor
10G Motor
10H Motor
11A Controller
11B Controller
11E Controller
11G Controller
11H Controller
12 Fan
13A Speed-reducing mechanism
13B Speed-reducing mechanism
13E Speed-reducing mechanism
13G Speed-reducing mechanism
13H Speed-reducing mechanism
14 Spindle
14A Flange portion
14B Spindle-shaft portion
14C Protruding part
15A Impact mechanism
15B Impact mechanism
15E Impact mechanism
15F Impact mechanism
15G Impact mechanism
15H Impact mechanism
16A Anvil
16B Anvil
16E Anvil
16F Anvil
16G Anvil
16H Anvil
17A Trigger switch
17B Trigger switch
17E Trigger switch
17G Trigger switch
17H Trigger switch
21E Main-body part
21G Main-body part
23A Grip part
23B Grip part
23G Grip part
31A Battery-mounting part
31B Battery-mounting part
31C Battery-mounting part
31D Battery-mounting part
31E Battery-mounting part
31F Battery-mounting part
31G Battery-mounting part
31H Battery-mounting part
33A Battery pack
33B Battery pack
33C Battery pack
33D Battery pack
33E Battery pack
33F Battery pack
33G Battery pack
33H Battery pack
47 Stator
47A Stator core
47B Coil
48 Rotor
49 Rotor shaft
50 Sensor board
51 Rotor bearing
52 Rotor bearing
55 Planetary-gear mechanism
55A Pin
55I Internal gear
55P Planet gear
55S Sun gear
58 Spindle bearing
71 Hammer
71A Hammer body
71C Recessed portion
72 Ball
73 First coil spring
74 Second coil spring
76 Washer
78 Ball
79 Anvil bearing
161 Anvil-shaft portion
162 Anvil-projection portion
231A First grip part
232A Second grip part
231B First grip part
232B Second grip part
231E Grip part
232E First handle
233E Second handle
232F First handle part
233F Second handle part
231H First grip part
232H Second grip part

Da Outer diameter

Db Distance

AX Rotational axis

1. An impact wrench comprising:
a brushless motor comprising a stator and a rotor, which rotates relative to the stator;
an impact mechanism, which is rotated by the rotor;
an anvil, which is impacted by the impact mechanism; and
one or more battery-mounting parts, on which one or more battery packs is (are respectively) mounted;
wherein the maximum fastening torque of the anvil is 3,200 N·m or more.

2. The impact wrench according to claim 1, wherein:
the sum total of the rated voltage(s) of the battery pack(s) is 36 V or more; and
the outer diameter of the stator is 50 mm or more.

3. The impact wrench according to claim 2, wherein the maximum output of the brushless motor is 1,250 W or more.

4. The impact wrench according to claim 2, further comprising:
a speed-reducing mechanism, which reduces the speed of the rotation of the rotor and transmits such rotation to the impact mechanism;
wherein the impact wrench is configured to rotate the anvil at a rotational speed of 600 rpm or more and 2,400 rpm or less.

5. The impact wrench according to claim 2, wherein the impact wrench is configured such that the impact rate of the impact mechanism is 900 ipm or more and 3,200 ipm or less.

6. The impact wrench according to claim 2, wherein the weight of a hammer of the impact mechanism is 0.55 kg or more and 2.2 kg or less.

7. The impact wrench according to claim 2, further comprising:
a speed-reducing mechanism, which reduces the rotational speed of the rotor and transmits such rotation to the impact mechanism;
wherein the speed-reduction ratio of the speed-reducing mechanism is 1/60 or more and 1/15 or less.

8. The impact wrench according to claim 2, wherein:
a tip portion of the anvil, on which a socket is mountable, has a square-columnar shape; and
the distance between a first side and a second side, which oppose each other, of the tip portion of the anvil is 1 inch or more and 2.5 inches or less.

9. An impact wrench comprising:
a brushless motor comprising a stator and a rotor, which rotates relative to the stator;
an impact mechanism, which is rotated by the rotor;
an anvil, which is impacted by the impact mechanism; and
one or more battery-mounting parts, on which one or more battery packs is (are respectively) mounted;
wherein the maximum fastening torque of the anvil is 6,000 N·m or more.

10. The impact wrench according to claim 9, wherein:
the sum total of the rated voltage(s) of the battery pack(s) is 72 V or more; and
the outer diameter of the stator is 60 mm or more.

11. The impact wrench according to claim 10, wherein the maximum output of the brushless motor is 2,500 W or more.

12. The impact wrench according to claim 10, further comprising:
a speed-reducing mechanism, which reduces the speed of the rotation of the rotor and transmits such rotation to the impact mechanism;
wherein the impact wrench is configured to rotate the anvil at a rotational speed of 600 rpm or more and 2,400 rpm or less.

13. The impact wrench according to claim 10, wherein the impact wrench is configured such that the impact rate of the impact mechanism is 900 ipm or more and 3,200 ipm or less.

14. The impact wrench according to claim 10, wherein the weight of a hammer of the impact mechanism is 1.1 kg or more and 4.4 kg or less.

15. The impact wrench according to claim 10, further comprising:
a speed-reducing mechanism, which reduces the rotational speed of the rotor and transmits such rotation to the impact mechanism;
wherein the speed-reduction ratio of the speed-reducing mechanism is 1/60 or more and 1/15 or less.

16. The impact wrench according to claim 10, wherein:
a tip portion of the anvil, on which a socket is mountable, has a square-columnar shape; and
the distance between a first side and a second side, which oppose each other, of the tip portion of the anvil is 1 inch or more and 2.5 inches or less.

17. An impact wrench comprising:
a brushless motor comprising a stator and a rotor, which rotates relative to the stator;
an impact mechanism, which is rotated by the rotor;
an anvil, which is impacted by the impact mechanism; and
one or more battery-mounting parts, on which one or more battery packs is (are respectively) mounted;
wherein the maximum fastening torque of the anvil is 10,000 N·m or more.

18. The impact wrench according to claim 17, wherein:
the sum total of the rated voltage(s) of the battery pack(s) is 144 V or more; and
the outer diameter of the stator is 60 mm or more.

19. The impact wrench according to claim 18, wherein the maximum output of the brushless motor is 5,000 W or more.

20. The impact wrench according to claim 18, further comprising:
a speed-reducing mechanism, which reduces the speed of the rotation of the rotor and transmits such rotation to the impact mechanism;
wherein the impact wrench is configured to rotate the anvil at a rotational speed of 600 rpm or more and 2,400 rpm or less.

21. The impact wrench according to claim 18, wherein the impact wrench is configured such that the impact rate of the impact mechanism is 900 ipm or more and 3,200 ipm or less.

22. The impact wrench according to claim 18, wherein the weight of a hammer of the impact mechanism is 2.2 kg or more and 3.8 kg or less.

23. The impact wrench according to claim 18, further comprising:
a speed-reducing mechanism, which reduces the rotational speed of the rotor and transmits such rotation to the impact mechanism;
wherein the speed-reduction ratio of the speed-reducing mechanism is 1/60 or more and 1/15 or less.

24. The impact wrench according to claim 18, wherein:
a tip portion of the anvil, on which a socket is mountable, has a square-columnar shape; and
the distance between a first side and a second side, which oppose each other, of the tip portion of the anvil is 1 inch or more and 2.5 inches or less.

25. The impact wrench according to claim 1, wherein the battery capacity of the (each) battery pack is 5 Ah or more.

26. The impact wrench according to claim 1, wherein the impact wrench is configured such that an electric current supplied to the brushless motor is 80 A or less.

27. The impact wrench according claim 1, wherein the impact wrench is configured such that an impact energy per impact produced by the impact mechanism is 95 J or more.

28. The impact wrench according to claim 1, wherein:
a rotational axis of the rotor extends in an up-down direction, and
a spring biases a hammer of the impact mechanism downward toward the anvil.

29. The impact wrench according to claim 28, wherein:
the impact mechanism is configured such that the hammer of the impact mechanism imparts consecutive rotational impacts on the anvil at a rate of two impacts per rotation of the hammer.

30. The impact wrench according to claim 1, wherein:
a rotational axis of the rotor extends in an up-down direction, and
a loop-shaped handle is disposed on an upper portion of the impact wrench.

31. The impact wrench according to claim 1, wherein:
a stator core of the stator includes a plurality of stacked steel plates, and
the length of the stacked steel plates in a direction of a rotational axis of the rotor is 24 mm or more.

32. The impact wrench according to claim 1, further comprising:
a trigger switch configured to control driving of the brushless motor;
a first grip on which the trigger switch is provided; and
a second grip on which the trigger switch is not provided.

33. The impact wrench according to claim 32, wherein:
the first grip and the second grip are each made of a metal, and
the second grip is configured to be undetachable.

34. The impact wrench according to claim 32, further comprising a loop-shaped handle disposed on an upper portion of the impact wrench.

35. The impact wrench according to claim 1, wherein:
a rotor core of the rotor contains a first number of rotor magnets,
the stator contains a second number of teeth, and
the first number is greater than the second number.

36. The impact wrench according to claim 35, wherein:
the brushless motor is configured to output a motor torque of 2.0 N·m or more and 11.0 N·m or less, and
the brushless motor is configured to rotate the rotor at a rotational speed of 3,000 rpm or more and 4,300 rpm or less.

37. The impact wrench according to claim 36, wherein the brushless motor includes:
at least one coil wound on a stator core of the stator; and
the rotor magnets fixed to the rotor core,
wherein:
the rotor magnets have a residual magnetic flux density of 1.32 T or more; and
the rotor magnets have a coercive force of 971 kA/m or more.

38. The impact wrench according to claim 1, further comprising an elastic member disposed between the motor and the one or more battery-mounting parts.

39. The impact wrench according to claim 1, wherein:
the (each) battery pack has a nominal voltage of at least 36 volts and a nominal capacity of at least 5 Ah, and
the impact wrench is configured to convert continuous torque input from the brushless motor into the maximum fastening torque of the anvil of 3,200 N·m or more without exceeding 80 A of current drawn by the brushless motor.

40. The impact wrench according to claim 1, wherein the mass of a hammer of the impact mechanism is at least 1 kg.

41. The impact wrench according to claim 1, further comprising:
a speed-reducing mechanism, which reduces the speed of the rotation of the rotor and transmits such rotation to the impact mechanism,
wherein the speed-reducing mechanism includes a multi-stage planetary-gear mechanism having at least two stages of planet gears.
